(19) United States
(12) Patent Application Publication
(10) Pub. No.: US 2008/0121246 A1
(43) Pub. Date: May 29, 2008

(54) Nail-Art Applicator

(76) Inventors: Yuko Saito, Tokyo (JP); Masumi Mitsunaga, Tokyo (JP)

Correspondence Address: MCDERMOTT WILL & EMERY LLP, 600 13TH STREET, N.W., WASHINGTON, DC, 20005-3096, US

(21) Appl. No.: 11/795,953

(22) PCT Filed: Jan. 23, 2006
(86) PCT No.: PCT/JP2006/300967

§ 371 Date: Jul. 25, 2007

(30) Foreign Application Priority Data
Jan. 25, 2005 (JP) 2005-016357

(51) Int. Cl. A45D 29/00; B43K 5/00

(52) U.S. Cl. 132/74.5; 132/73; 132/285; 401/205; 401/196

(57) ABSTRACT

It is intended to provide an applicator, by which a line with a constant width can be accurately and easily drown on the nail either by the dominant hand or the non-dominant hand, in enjoying nail art (i.e., painting nails), in particular, French nail. Namely, an applicator for nail art (1) comprising the main applicator part made of porous material, a raised fabric material or a brush-like material, which is capable of absorbing and retaining a liquid, provided with a nail guide member (3) for leading a nail tip and a nail application member (4) which is attached to the nail guide member (3) and has a flat surface suitable for the application. In a preferred case, two or more pairs of the nail guide member and nail application member are employed.

### TECHNICAL FIELD

The present invention relates to applicators used for manicures such as in the painting of pictures on nails, and in particular, relates to nail-art applicators preferably used for drawing lines on the tips of nails as in French manicures. The present invention relates to cosmetic-related technology.

### BACKGROUND ART

To date, nail polish has been applied on nails as makeup for nails. For such makeup, brushes primarily composed of hair are widely used as applicators of nail polish. Furthermore, improvements in applicators of nail polish including brushes are being made constantly.

For example, a brush capable of appropriately applying high-viscosity nail polish is disclosed in Japanese Unexamined Patent Application Publication No. 10-295440 (Patent Document 1). The brush includes a bunch of stiff hairs fixed at one end of a rod, and ends of the stiff hairs are aligned substantially in the direction of the axis of the rod.

Moreover, Japanese Unexamined Patent Application Publication No. 2004-59035 (Patent Document 2) discloses an applicator suited for manicuring having an applicator body formed of a hard core (bar-shaped body) of a synthetic resin or a fiber bundle. Anybody using this applicator can draw fine patterns, and moreover, the applicator has a long product life.

Furthermore, in order to provide French manicures formed by applying nail polish on the entire surfaces of nails and drawing lines on the tips of the nails using another nail polish of a different color, Japanese Unexamined Patent Application Publication No. 2004-8826 (Patent Document 3) discloses a brush for easily drawing lines, usually white lines, including a brush portion having an arc-shaped cross section and a U-shaped end portion when viewed in plan.

The above-described applicators each have specific features. However, the applicators are not suitable for or need some improvements in drawing patterns having lines with a constant width on surfaces of nails, in particular, in drawing patterns having lines of white hues formed on the tips of the nails (referred to as French manicures).

That is, when the brush suitable for applying nail polish on the entire surfaces of nails disclosed in Patent Document 1 is used for drawing lines of white hues on the tips of the nails, the brush is moved along the edges of the nails. Since the brush has no devices for drawing lines, lines can become warped or unaligned. Thus, it is difficult to draw lines with the same width on all the nails. In particular, it is extremely difficult to accurately draw lines on the nails of a dominant hand.

In order to solve this problem, masking tape can be used. However, when pieces of masking tape stuck on the nails are removed after nail polish is applied, lines can become warped or the applied nail polish can peel off. To begin with, it is difficult to accurately stick pieces of masking tape on the nails of all fingers along the lines to be drawn.

Moreover, the bar-shaped applicator as disclosed in Patent Document 2 is suitable for drawing fine patterns. However, the applicator is not suitable for drawing lines having a certain width. If the applicator abandons the advantage of drawing fine patterns and the diameter of the end of the bar-shaped applicator is increased such that thick lines are drawn, the applicator still has the same problem as that of the above-described brush.

Moreover, the brush disclosed in Patent Document 3 is developed for providing French manicures, and has an arc-shaped cross section and a U-shaped end portion when viewed in plan for allowing users to easily draw white lines on the tips of nails. However, each person has their own nail shapes, and moreover, the widths of lines cannot be regulated. This requires sense and skill of users, resulting in difficulty in drawing lines having the same width on all the nails.

With consideration of the above-described situations, it is an object of the present invention to provide an applicator allowing users to accurately and easily draw lines with constant widths on their nails using either dominant hands or non-dominant hands in the case of manicures such as in the painting of pictures on nails, and in particular, in the case of French manicures.

Patent Document 1: Japanese Unexamined Patent Application Publication No. 10-295440

Patent Document 2: Japanese Unexamined Patent Application Publication No. 2004-59035

Patent Document 3: Japanese Unexamined Patent Application Publication No. 2004-8826

### DISCLOSURE OF INVENTION

In order to achieve the above-described object, the present invention provides a nail-art applicator including a bar-shaped applicator body capable of absorbing and retaining liquid, a guiding portion formed on the applicator body for guiding the applicator along a tip of a nail, and an applying portion connected to the guiding portion and having a flat or curved surface.

Moreover, the nail-art applicator is characterized in that the applicator body includes a plurality of pairs of the guiding portion and the applying portion.

Moreover, the nail-art applicator is characterized in that the applying portions in the different pairs each have a specific application length.

Moreover, the nail-art applicator is characterized in that an angle formed between the guiding portion and the side surface of the applicator body is smaller than or equal to 90°.

Moreover, the nail-art applicator is characterized in that the guiding portion has a height ranging from 0.2 to 2.5 mm from the point at which the guiding portion intersects the applying portion.

Moreover, the nail-art applicator is characterized in that the applicator body is composed of a porous material, a raised material, or a flocked material which is capable of absorbing and retaining liquid using capillary attraction.

Furthermore, the nail-art applicator is characterized in that the porous material is composed of a fiber bundle hardened using a synthetic resin.

The nail-art applicator according to the present invention includes the bar-shaped applicator body having the guiding portion for guiding the applicator along a tip of a nail and the applying portion connected to the guiding portion and having a flat or curved surface for applying nail polish on the nail. With this, lines having a predetermined width, i.e., corresponding to the length of the applying portion, can be uniformly and accurately drawn on the tips of nails with ease by applying nail polish using the applying portion while the guiding portion is moved along the tips of the nails. Furthermore, the nail polish can be applied on the side surfaces of the tips of the nails at the same time. In addition, lines can be drawn on the nails of a dominant hand without any problems.

In particular, when the nail-art applicator according to the present invention includes a plurality of pairs of the guiding portion and the applying portion, a plurality of types of lines, for example, lines of 5 mm wide for nails of thumbs and lines of 3 mm wide for nails of other fingers when two applying portions having lengths of 3 mm and 5 mm are formed on the surface of the bar-shaped body, can be optionally drawn in accordance with the lengths of nails or users preference. As a matter of course, three or more applying portions each having a specific length can be formed on the bar-shaped body so as to draw more types of lines. Moreover, when two applying portions having the same length are formed on the bar-shaped body, the decreased life span of the applicator caused by wear or the like on the applying portions can be extended.

Moreover, the edge portion of the bar-shaped nail-art applicator according to the present invention can be used for drawing delicate patterns as shown in Patent Document 2, and users can enjoy drawing delicate and fine pictures on their nails.

### BRIEF DESCRIPTION OF THE DRAWINGS

FIG. 1 is a side view illustrating an example of a nail-art applicator according to the present invention;

FIG. 2 is a side view illustrating another example of the nail-art applicator according to the present invention; and

FIGS. 3(a) to 3(c) illustrate how a straight line is drawn on a nail using the nail-art applicator according to the present invention.

In the drawings, reference numbers 1, 2, 3, 4, 5, and 6 denote a nail-art applicator, an applying portion, a guiding portion, a pen-type applying tool, a nail, and a straight line, respectively. Reference marks [symbol] and [symbol] denote the length of applying portion and the length of the guiding portion, respectively.

### BEST MODE FOR CARRYING OUT THE INVENTION

A nail-art applicator according to a concrete embodiment of the present invention will now be described with reference to the drawings.

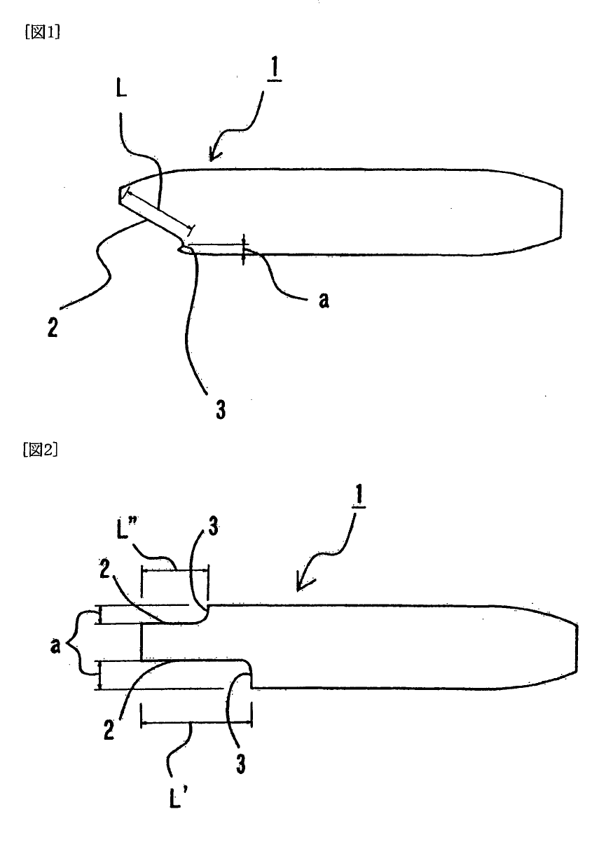

As shown in FIG. 1, a nail-art applicator 1 is formed of a bar-shaped applicator body having a circular cross section, the diameters at both ends being reduced. The nail-art applicator 1 includes a flat applying portion 2 for applying nail polish formed by cutting off a part of the applicator body at one end of the nail-art applicator 1 and a guiding portion 3 for guiding nails connected to the applying portion 2.

In order to apply nail polish on nails without patchiness, the bar-shaped applicator body is preferably composed of a material capable of absorbing and retaining a large amount of nail polish, and is not preferably composed of simple materials such as wood, plastics, and glass. The applicator body is preferably composed of a porous material such as foam having open cells, a raised material, or a flocked material, which is capable of absorbing and retaining liquid using capillary attraction. More preferably, the applicator body is composed of a fiber bundle, a type of porous material formed by bundling fibers and hardening the bundle using a synthetic resin, having an appropriate strength. Yet more preferably, the applicator body is composed of a fiber bundle having a high liquid-absorbency and a porosity of 50% or more.

The applicator body preferably has a bar-like cylindrical shape as shown in FIG. 1. However, a prismatic (square bar) shape is also applicable. The dimensions of the applicator body are preferably 4 to 5 mm in diameter and 20 to 30 mm in length. However, the length and the width can be changed in accordance with required characteristics.

The applying portion 2 is formed by cutting off a part of the applicator body so as to form a flat surface. When this applying portion 2 is used for drawing straight lines on nails using nail polish, straight lines having a width corresponding to the length [symbol] shown in FIG. 1 can be formed.

The surface of the applying portion 2 can be curved instead of being flat so as to be fitted on nails.

The nail-art applicator 1 shown in FIG. 1 has only one applying portion 2. However, two applying portions 2 can be formed as shown in FIG. 2. In that case, a nail-art applicator 1 capable of drawing two types of lines having different widths can be realized by setting the lengths [symbol] and [symbol] of the applying portions 2 to differ from each other, for example, 3 mm and 5 mm.

Moreover, when the applying portions 2 have the same length, the decreased life span of the nail-art applicator 1 caused by wear on the applying portions 2 can be extended.

Furthermore, three, four, or more applying portions 2 can be formed on the applicator body by sectioning the outer periphery of the applicator body into three, four, or more. Moreover, sharp portions on the tip of the applicator body can also be used for drawing delicate pictures.

The guiding portion 3 is one of major features of the present invention. The guiding portion 3 is connected to the applying portion 2, and guides the applying portion 2 while a line is drawn on a nail using the applying portion 2. When the applying portion 2 is moved while the guiding portion 3 is pressed toward the tip of a nail on which a line is to be drawn, a line having a constant width can be accurately drawn very easily.

In order to make the most of the above-described function of the guiding portion 3, the length a of the guiding portion 3 preferably ranges from 0.2 to 2.5 mm. When the length is smaller than 0.2 mm, guidance along a nail becomes difficult. On the other hand, when the length is larger than 2.5 mm, the guiding portion 3 can be brought into contact with a finger. This also leads to difficulty in guiding the applicator along a nail.

Moreover, the angle formed between the guiding portion 3 and the side surface of the bar-shaped body is preferably 900 or less. When the angle exceeds 900, the applying portion 2 slips during guidance of the applying portion 2 along the tip of a nail, and forms a warped line undesirably.

The nail-art applicator 1 according to the present invention can be used in a similar manner to known brushes for applying nail polish. The nail-art applicator 1 can be used instead of applying portions disposed at ends of applicators of the dip type disclosed in, for example, Patent Documents 1 to 3, or can be used as end portions of pen-type applying tools of the ink-absorbing core type such as the ink-tampon system pen, the valve cushion system pen and the push system pen.

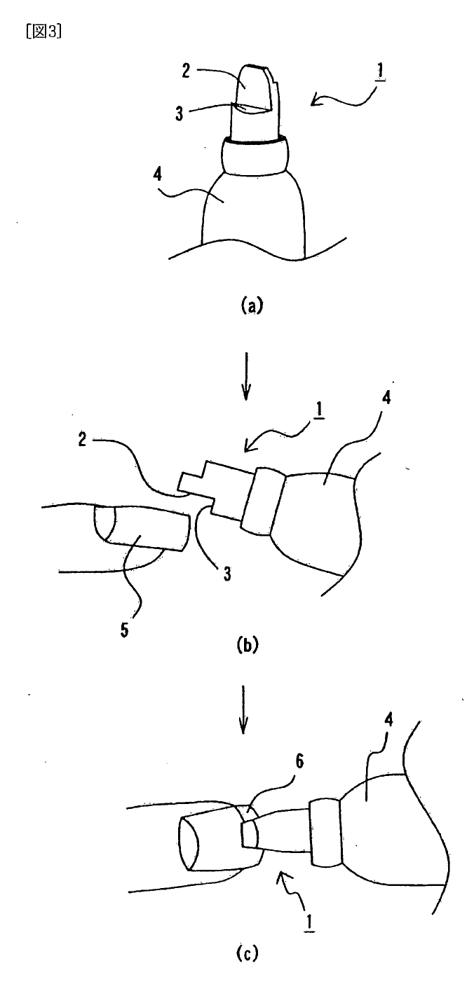

FIGS. 3(a) to 3(c) illustrate how a line is drawn on a nail using the nail-art applicator 1 according to the present invention. As shown in FIG. 3(a), the nail-art applicator 1 is fitted into an end portion of a pen-type applying tool 4. The tip of a nail 5 is brought into contact with the guiding portion 3 as shown in FIG. 3(b), and the guiding portion 3 is moved along the tip of the nail 5 as shown in FIG. 3(c). With this, nail polish fed from a reservoir (not shown) in the pen-type applying tool 4 is applied to the nail 5 using the applying portion 2, and a line 6 having a predetermined width can be formed.

When foam or a flocked material is selected as a material for the applicator body, the guiding portion and the applying portion can be molded using a molding die. Moreover, in the case of the flocked material, the material can be obtained by performing a post-processing such as electrostatic flocking on the surface of a molded body obtained by the above-described molding process.

Moreover, the nail polish can be appropriately selected in accordance with purpose, and the types (solvent-based or water-based, high viscosity or low viscosity, and the like) and ingredients of coating materials are not limited. Moreover, when the nail polish has low coating durability, topcoat or the like is preferably applied on the nail polish so as to increase the durability.

Furthermore, when the applying portion 2 and the guiding portion 3 are formed, the applying portion 2 is formed along the axis of the applicator body, and then the guiding portion 3 is formed in a direction perpendicular to the axis as shown in the drawings. However, although not shown, the guiding portion can be formed along the axis of the applicator body, and then the applying portion can be formed in the direction perpendicular to the axis as a matter of course.

### EXAMPLE 1

A fiber bundle hardened using a synthetic resin and having a cylindrical-bar shape was cut in accordance with the shape shown in FIG. 1 such that an applying portion of 3 mm long having a guiding portion of 1 mm long formed at an end of the applying portion was formed on the outer periphery of the applicator body.

The applicator formed as above was installed in a dip-type container as an applying part, and immersed in nail polish in the container. The applicator was taken out of the container, and excessive nail polish was removed from the applicator. Subsequently, straight lines were drawn on nails using the applying portion by moving the guiding portion along the tips of the nails. As a result, straight lines of 3 mm wide could be finely and accurately drawn without any problems.

### EXAMPLE 2

A fiber bundle hardened using a synthetic resin and having a cylindrical-bar shape was cut in accordance with the shape shown in FIG. 2 such that an applying portion of 5 mm long having a guiding portion of 1.3 mm long formed at an end of the applying portion and an applying portion of 3 mm long having a guiding portion of 1.2 mm long formed at an end of the applying portion were symmetrically formed on the outer periphery of the applicator body. The applicator formed as above was installed on the end of a valve cusion system pen. A thick line (5 mm) was drawn on a nail of a thumb using the larger applying portion, and thin lines (3 mm) were drawn on nails of four fingers using the smaller applying portion. As a result, straight lines could be finely and accurately drawn without any problems.

### INDUSTRIAL APPLICABILITY

A nail-art applicator according to the present invention allows users to accurately and easily draw straight or curved lines with constant widths on their nails using either dominant hands or non-dominant hands such that users can perform popular French manicures themselves. Thus, there is a high probability that the nail-art applicator according to the present invention will come into widespread use in the cosmetic industry as a cosmetic-related item.

1. A nail-art applicator comprising:
a bar-shaped applicator body capable of absorbing and retaining liquid;
a guiding portion formed on the applicator body for guiding the applicator along a tip of a nail; and
an applying portion connected to the guiding portion and having a flat or curved surface.

2. The nail-art applicator according to claim 1, wherein
the applicator body includes a plurality of pairs of the guiding portion and the applying portion.

3. The nail-art applicator according to claim 2, wherein
the applying portions in the different pairs each have a specific application length.

4. The nail-art applicator according to any one of claims 1 to 3, wherein
an angle formed between the guiding portion and the side surface of the applicator body is smaller than or equal to 90°.

5. The nail-art applicator according to any one of claims 1 to 4, wherein
the guiding portion has a height ranging from 0.2 to 2.5 mm from the point at which the guiding portion intersects the applying portion.

6. The nail-art applicator according to any one of claims 1 to 5, wherein
the applicator body is composed of a porous material, a raised material, or a flocked material, which is capable of absorbing and retaining liquid using capillary attraction.

7. The nail-art applicator according to claim 6, wherein
the porous material is composed of a fiber bundle hardened using a synthetic resin.
